(19) United States
(12) Patent Application Publication
(10) Pub. No.: US 2013/0304697 A1
(43) Pub. Date: Nov. 14, 2013

(54) SYSTEM AND METHOD FOR CROSS-PLATFORM SYNCHRONIZATION OF DATA OBJECTS IN A MULTI-TENANT ENVIRONMENT

(71) Applicant: salesforce.com, inc., (US)

(72) Inventor: Mark Movida, Berkley, CA (US)

(73) Assignee: SALESFORCE.COM, INC., San Francisco, CA (US)

(21) Appl. No.: 13/834,767

(22) Filed: Mar. 15, 2013

Related U.S. Application Data
(60) Provisional application No. 61/644,535, filed on May 9, 2012.

(51) Int. Cl. G06F 17/30

(52) U.S. Cl. CPC G06F 17/30575
USPC 707/610

(57) ABSTRACT

Methods and systems are provided for synchronizing files in a multi-tenant computing environment of the type including a server, a multi-tenant database, and a local computer connected to the multi-tenant database through a network cloud. The method seamlessly synchronizes data objects in the multi-tenant database with corresponding data objects on the local computing device. The method includes running a client application on a local computing device, updating a first file on the local computing device, and automatically updating a second file in a remote multi-tenant database corresponding to the first file upon updating the first file.

### CROSS-REFERENCE TO RELATED APPLICATION

This application claims the benefit of U.S. provisional patent application Ser. No. 61/644,535, filed May 9, 2012, the entire content of which is incorporated by reference herein.

### TECHNICAL FIELD

Embodiments of the subject matter described herein relate generally to computer systems and applications for synchronizing data objects and, more particularly, to a method for automatically synchronizing files between a cloud-based multi-tenant environment and a client application running on a desktop or mobile computing device.

### BACKGROUND

Modern software development is evolving away from the client-server model toward network-based processing systems that provide access to data and services via the Internet or other networks. In contrast to traditional systems that host networked applications on dedicated server hardware, a “cloud” computing model allows applications to be provided over the network “as a service” supplied by an infrastructure provider. The infrastructure provider typically abstracts the underlying hardware and other resources used to deliver a customer-developed application so that the customer no longer needs to operate and support dedicated server hardware. The cloud computing model can often provide substantial cost savings to the customer over the life of the application because the customer no longer needs to provide dedicated network infrastructure, electrical and temperature controls, physical security and other logistics in support of dedicated server hardware.

Multi-tenant cloud-based architectures have been developed to improve collaboration, integration, and community-based cooperation between customer tenants without sacrificing data security. Generally speaking, multi-tenancy refers to a system where a single hardware and software platform simultaneously supports multiple user groups (also referred to as “organizations” or “tenants”) from a common data storage element (also referred to as a “multi-tenant database”). The multi-tenant design provides a number of advantages over conventional server virtualization systems. First, the multi-tenant platform operator can often make improvements to the platform based upon collective information from the entire tenant community. Additionally, because all users in the multi-tenant environment execute applications within a common processing space, it is relatively easy to grant or deny access to specific sets of data for any user within the multi-tenant platform, thereby improving collaboration and integration between applications and the data managed by the various applications. The multi-tenant architecture therefore allows convenient and cost effective sharing of similar application features between multiple sets of users.

Presently known methods for updating data objects (files) stored on the multi-tenant database involve manually creating or updating the file locally, logging onto a web-based interface to access the multi-tenant environment, and manually uploading each new file to the multi-tenant database. However, manual file synchronization can be cumbersome, time consuming, and error prone.

Moreover, cloud-based computing environments are experiencing an increasing demand for mobile devices and applications; that is, many users of multi-tenant and/or on demand data services are mobile, and seek to add, delete, and update files which contain data records for mobile devices. Along with the increasing mobilization of the multi-tenant community comes an enhanced need for efficient and error free synchronization of data objects between the local user and the multi-tenant database.

Systems and methods are thus needed for updating data objects locally, and for automatically synchronizing the updated files between the local device and the cloud-based multi-tenant environment.

### BRIEF DESCRIPTION OF THE DRAWING FIGURES

A more complete understanding of the subject matter may be derived by referring to the detailed description and claims when considered in conjunction with the following figures, wherein like reference numbers refer to similar elements throughout the figures.

FIG. 1 is a schematic block diagram of a multi-tenant computing environment in accordance with an embodiment;

FIG. 2 is a screen shot showing a technique for navigating through a desk top icon to reveal a menu for interacting with the synchronization application in accordance with an embodiment;

FIG. 3 is a screen shot showing a file manager feature of the synchronization application in accordance with an embodiment;

FIG. 4 is a conceptual system diagram implementing the file synchronization application in a multi-tenant environment in accordance with an embodiment; and

FIG. 5 is a flow chart illustrating an exemplary method of using the file synchronization manager in accordance with an embodiment.

### DETAILED DESCRIPTION

Embodiments of the subject matter described herein generally relate to systems and methods for automatically synchronizing locally created and updated files with a remote multi-tenant database, without having to separately log on to a web-based portal and manually upload the updated files.

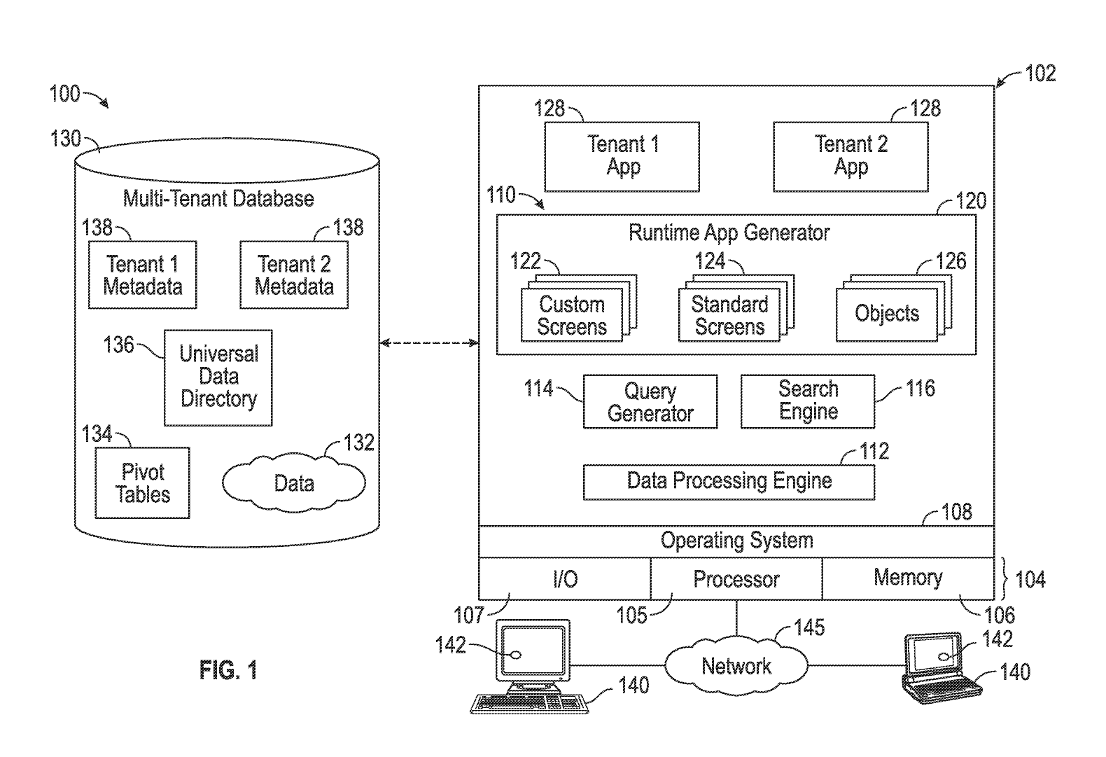

Turning now to FIG. 1, an exemplary multi-tenant system 100 includes a server 102 that dynamically creates and supports virtual applications 128 based upon data 132 from a database 130 that may be shared between multiple tenants, referred to herein as a multi-tenant database. Data and services generated by the virtual applications 128 are provided via a network 145 to any number of client devices 140, as desired. Each virtual application 128 is suitably generated at run-time (or on-demand) using a common application platform 110 that securely provides access to the data 132 in the database 130 for each of the various tenants subscribing to the multi-tenant system 100. In accordance with one non-limiting example, the multi-tenant system 100 is implemented in the form of an on-demand multi-tenant customer relationship management (CRM) system that can support any number of authenticated users of multiple tenants.

As used herein, a “tenant” or an “organization” should be understood as referring to a group of one or more users that shares access to common subset of the data within the multi-tenant database 130. In this regard, each tenant includes one or more users associated with, assigned to, or otherwise belonging to that respective tenant. Stated another way, each respective user within the multi-tenant system 100 is associated with, assigned to, or otherwise belongs to a particular one of the plurality of tenants supported by the multi-tenant system 100. Tenants may represent companies, corporate departments, business or legal organizations, and/or any other entities that maintain data for particular sets of users (such as their respective customers) within the multi-tenant system 100. Although multiple tenants may share access to the server 102 and the database 130, the particular data and services provided from the server 102 to each tenant can be securely isolated from those provided to other tenants. The multi-tenant architecture therefore allows different sets of users to share functionality and hardware resources without necessarily sharing any of the data 132 belonging to or otherwise associated with other tenants.

The multi-tenant database 130 may be a repository or other data storage system capable of storing and managing the data 132 associated with any number of tenants. The database 130 may be implemented using conventional database server hardware. In various embodiments, the database 130 shares processing hardware 104 with the server 102. In other embodiments, the database 130 is implemented using separate physical and/or virtual database server hardware that communicates with the server 102 to perform the various functions described herein. In an exemplary embodiment, the database 130 includes a database management system or other equivalent software capable of determining an optimal query plan for retrieving and providing a particular subset of the data 132 to an instance of virtual application 128 in response to a query initiated or otherwise provided by a virtual application 128, as described in greater detail below. The multi-tenant database 130 may alternatively be referred to herein as an on-demand database, in that the multi-tenant database 130 provides (or is available to provide) data at run-time to on-demand virtual applications 128 generated by the application platform 110, as described in greater detail below.

In practice, the data 132 may be organized and formatted in any manner to support the application platform 110. In various embodiments, the data 132 is suitably organized into a relatively small number of large data tables to maintain a semi-amorphous “heap”-type format. The data 132 can then be organized as needed for a particular virtual application 128. In various embodiments, conventional data relationships are established using any number of pivot tables 134 that establish indexing, uniqueness, relationships between entities, and/or other aspects of conventional database organization as desired. Further data manipulation and report formatting is generally performed at run-time using a variety of metadata constructs. Metadata within a universal data directory (UDD) 136, for example, can be used to describe any number of forms, reports, workflows, user access privileges, business logic and other constructs that are common to multiple tenants.

Tenant-specific formatting, functions and other constructs may be maintained as tenant-specific metadata 138 for each tenant, as desired. Rather than forcing the data 132 into an inflexible global structure that is common to all tenants and applications, the database 130 is organized to be relatively amorphous, with the pivot tables 134 and the metadata 138 providing additional structure on an as-needed basis. To that end, the application platform 110 suitably uses the pivot tables 134 and/or the metadata 138 to generate “virtual” components of the virtual applications 128 to logically obtain, process, and present the relatively amorphous data 132 from the database 130.

The server 102 may be implemented using one or more actual and/or virtual computing systems that collectively provide the dynamic application platform 110 for generating the virtual applications 128. For example, the server 102 may be implemented using a cluster of actual and/or virtual servers operating in conjunction with each other, typically in association with conventional network communications, cluster management, load balancing and other features as appropriate. The server 102 operates with any sort of conventional processing hardware 104, such as a processor 105, memory 106, input/output features 107 and the like. The input/output features 107 generally represent the interface(s) to networks (e.g., to the network 145, or any other local area, wide area or other network), mass storage, display devices, data entry devices and/or the like.

The processor 105 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 106 represents any non-transitory short or long term storage or other computer-readable media capable of storing programming instructions for execution on the processor 105, including any sort of random access memory (RAM), read only memory (ROM), flash memory, magnetic or optical mass storage, and/or the like. The computer-executable programming instructions, when read and executed by the server 102 and/or processor 105, cause the server 102 and/or processor 105 to create, generate, or otherwise facilitate the application platform 110 and/or virtual applications 128 and perform one or more additional tasks, operations, functions, and/or processes described herein. It should be noted that the memory 106 represents one suitable implementation of such computer-readable media, and alternatively or additionally, the server 102 could receive and cooperate with external computer-readable media that is realized as a portable or mobile component or platform, e.g., a portable hard drive, a USB flash drive, an optical disc, or the like.

The application platform 110 is any sort of software application or other data processing engine that generates the virtual applications 128 that provide data and/or services to the client devices 140. In a typical embodiment, the application platform 110 gains access to processing resources, communications interfaces and other features of the processing hardware 104 using any sort of conventional or proprietary operating system 108. The virtual applications 128 are typically generated at run-time in response to input received from the client devices 140. For the illustrated embodiment, the application platform 110 includes a bulk data processing engine 112, a query generator 114, a search engine 116 that provides text indexing and other search functionality, and a runtime application generator 120. Each of these features may be implemented as a separate process or other module, and many equivalent embodiments could include different and/or additional features, components or other modules as desired.

The runtime application generator 120 dynamically builds and executes the virtual applications 128 in response to specific requests received from the client devices 140. The virtual applications 128 are typically constructed in accordance with the tenant-specific metadata 138, which describes the particular tables, reports, interfaces and/or other features of the particular application 128. In various embodiments, each virtual application 128 generates dynamic web content that can be served to a browser or other client program 142 associated with its client device 140, as appropriate.

The runtime application generator 120 suitably interacts with the query generator 114 to efficiently obtain multi-tenant data 132 from the database 130 as needed in response to input queries initiated or otherwise provided by users of the client devices 140. In a typical embodiment, the query generator 114 considers the identity of the user requesting a particular function (along with the user's associated tenant), and then builds and executes queries to the database 130 using system-wide metadata 136, tenant specific metadata 138, pivot tables 134, and/or any other available resources. The query generator 114 in this example therefore maintains security of the common database 130 by ensuring that queries are consistent with access privileges granted to the user and/or tenant that initiated the request.

With continued reference to FIG. 1, the data processing engine 112 performs bulk processing operations on the data 132 such as uploads or downloads, updates, online transaction processing, and/or the like. In many embodiments, less urgent bulk processing of the data 132 can be scheduled to occur as processing resources become available, thereby giving priority to more urgent data processing by the query generator 114, the search engine 116, the virtual applications 128, etc.

In exemplary embodiments, the application platform 110 is utilized to create and/or generate data-driven virtual applications 128 for the tenants that they support. Such virtual applications 128 may make use of interface features such as custom (or tenant-specific) screens 124, standard (or universal) screens 122 or the like. Any number of custom and/or standard objects 126 may also be available for integration into tenant-developed virtual applications 128. As used herein, “custom” should be understood as meaning that a respective object or application is tenant-specific (e.g., only available to users associated with a particular tenant in the multi-tenant system) or user-specific (e.g., only available to a particular subset of users within the multi-tenant system), whereas “standard” or “universal” applications or objects are available across multiple tenants in the multi-tenant system.

The data 132 associated with each virtual application 128 is provided to the database 130, as appropriate, and stored until it is requested or is otherwise needed, along with the metadata 138 that describes the particular features (e.g., reports, tables, functions, objects, fields, formulas, code, etc.) of that particular virtual application 128. For example, a virtual application 128 may include a number of objects 126 accessible to a tenant, wherein for each object 126 accessible to the tenant, information pertaining to its object type along with values for various fields associated with that respective object type are maintained as metadata 138 in the database 130. In this regard, the object type defines the structure (e.g., the formatting, functions and other constructs) of each respective object 126 and the various fields associated therewith.

Still referring to FIG. 1, the data and services provided by the server 102 can be retrieved using any sort of personal computer, mobile telephone, tablet or other network-enabled client device 140 on the network 145. In an exemplary embodiment, the client device 140 includes a display device, such as a monitor, screen, or another conventional electronic display capable of graphically presenting data and/or information retrieved from the multi-tenant database 130, as described in greater detail below.

Typically, the user operates a conventional browser application or other client program 142 executed by the client device 140 to contact the server 102 via the network 145 using a networking protocol, such as the hypertext transport protocol (HTTP) or the like. The user typically authenticates his or her identity to the server 102 to obtain a session identifier (“SessionID”) that identifies the user in subsequent communications with the server 102. When the identified user requests access to a virtual application 128, the runtime application generator 120 suitably creates the application at run time based upon the metadata 138, as appropriate.

As noted above, the virtual application 128 may contain Java, ActiveX, or other content that can be presented using conventional client software running on the client device 140; other embodiments may simply provide dynamic web or other content that can be presented and viewed by the user, as desired. As described in greater detail below, the query generator 114 suitably obtains the requested subsets of data 132 from the database 130 as needed to populate the tables, reports or other features of the particular virtual application 128.

In accordance with various embodiments, application 128 includes functionality which allows a user to update files locally on the desk top, lap top, or mobile device, and automatically synchronize the updated files with the multi-tenant database without having to separately open up a browser, access the multi-tenant database through a dedicated web interface, and manually upload each new file to the multi-tenant environment.

More particularly, presently known techniques for adding or updating files stored in a multi-tenant database typically require the user to open a web browser, log onto a dedicated web portal, and thereby access those files stored on the multi-tenant database which the user is authorized to access. The creation, deletion, and updating of data objects (files) is accomplished through direct interaction with the multi-tenant database via a web-based user interface. An exemplary user interface may include robust customer relationship management (CRM) tools such as those available at www.salesforce.com. The current paradigm does not afford the user the ability to create and modify existing files locally and offline, and then automatically synchronize the new and/or updated files with the remote multi-tenant database.

In accordance with various embodiments of the present disclosure, an enhanced file management application allows the user to create, delete, and revise files locally, and seamlessly synchronize those files with the multi-tenant database without having to separately log into the web-based portal. Conversely, files added to or updated in the multi-tenant database using the traditional web-based interface are similarly automatically synchronized to the desk top via the enhanced file management application, as discussed in greater detail below.

In an embodiment, a user may install the enhanced file management application on any lap top, desk top, or mobile computing device, and register the device with the server operating in the multi-tenant environment. The file manager includes a background process which maintains a persistent connection (e.g., 24 hours per day and seven days per week) between the device and the multi-tenant environment. The user may then update local versions of files, and automatically synchronize updated versions via the file manager without having to separately access the web-based interface.

In a further embodiment, the file manager comprises a cross-platform application running on the desk top or mobile computing device for seamlessly synchronizing a user's files with a cloud-based multi-tenant database. In the context of this disclosure, the term “cross-platform” implies that the synchronization engine is embodied in a single code base (i.e., application) configured to function across various platforms such as, for example, Windows™, Mac™, and Linux™ operating systems. In an embodiment, the synchronization application may be written in any suitable programming language such as the Mono™ cross-platform development tool kit available from Xamarin. While the non-limiting examples herein reference a standalone application, one or more implementations can also integrate the file manager with a web browser to facilitate connectivity between the local device and the multi-tenant database.

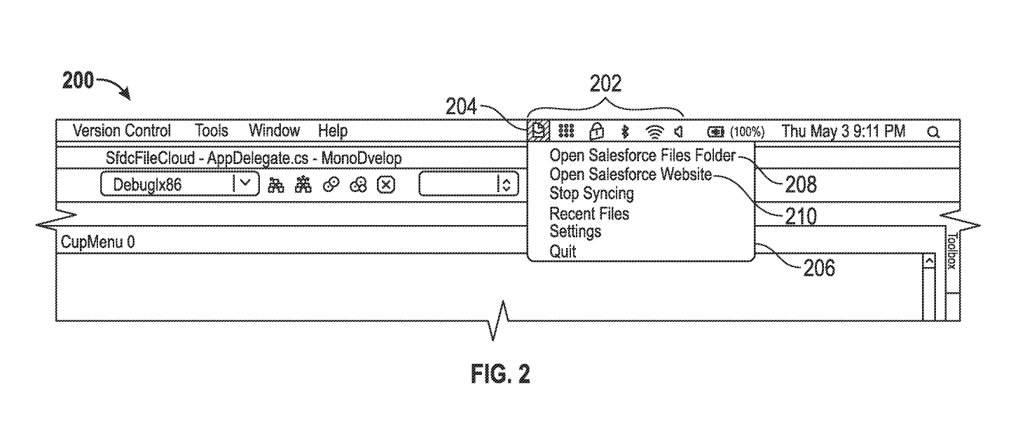

FIG. 2 is a screen shot 200 illustrating a desk top icon which, when selected, reveals a menu for interacting with a file synchronization application. More particularly, screen shot 200 includes a task bar (or start menu) 202 including a file manager icon 201. When clicked, the icon 204 reveals a menu 206 which facilities interaction with the underlying file management application.

The menu 206 includes various user-selectable items including an “open salesforce website” key 210 and an “open salesforce files folder” key 208. The website key 210 connects the user with the traditional web-based user interface, which provides a rich operating environment including the Salesforce™ CRM application and other customer management tools. Alternatively, the folder key opens a salesforce folder on the desk top.

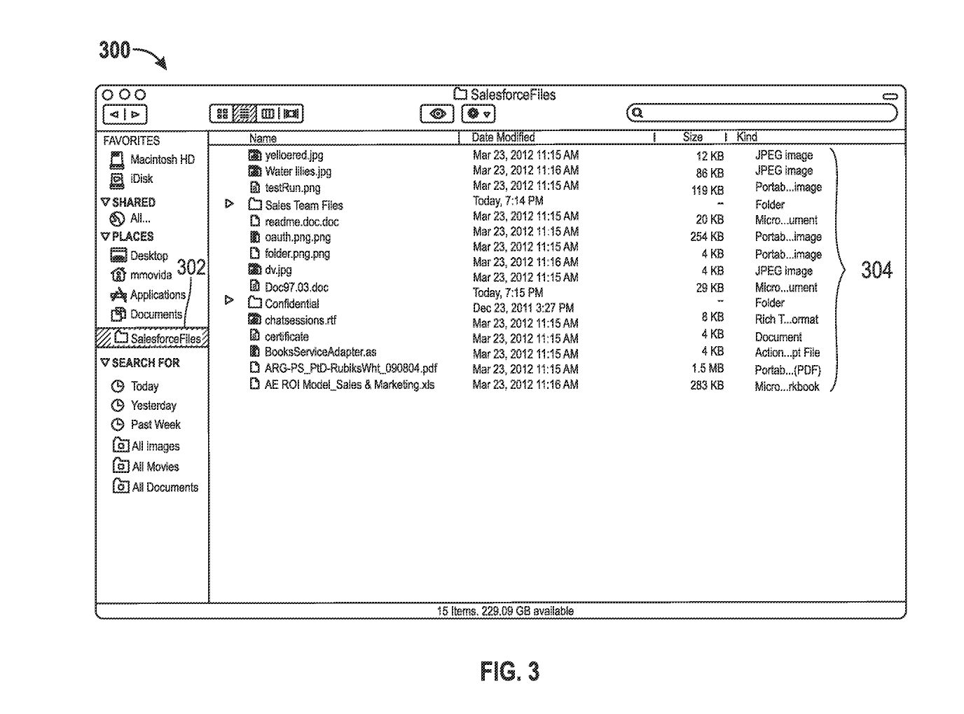

More particularly, FIG. 3 is a screen shot illustrating an enhanced file manager 300 including a salesforcefiles file 302 and its contents 304. The enhanced file manager 300 includes a connectivity feature that constantly runs on the desktop to maintain a persistent connection to the multi-tenant database. In this way, files which are updated by another authorized user are available in real time using file manager 300. In addition, when one of the files 304 is updated, the updated version of that file is available to other authorized users via the web-based user interface.

With continued reference to FIG. 3, new files may be quickly and easily added to the multi-tenant database by simple dragging and dropping the new file into the salesforcefiles folder 302.1

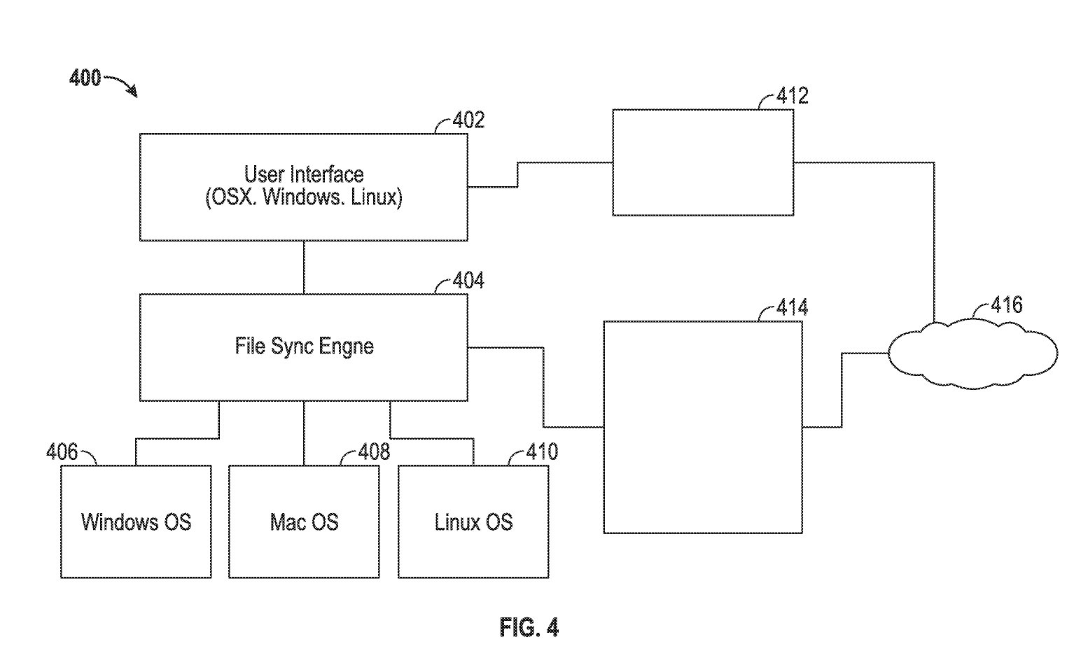

FIG. 4 is a conceptual system diagram implementing an exemplary file synchronization system 400 in a multi-tenant environment in accordance with an embodiment. More particularly, system 400 includes a file synchronization engine 404 embodied in the single code base comprising the enhanced file manager in one embodiment. In other embodiments, the file synchronization engine may operate independently from a file management application, or may be integrated into a web browser application.

With continued reference to FIG. 4, system 400 further includes a user interface module 402, such as file manager 300, and a plurality of operating system interface modules 406, 408, and 410 for interfacing and coordinating with the native operating system to monitor files and directories. System 400 also includes an authorization module 412 for authenticating the user within the multi-tenant environment 416, and application protocol interface (API) module 414 to facilitate various interactive functions between the local computing device and the multi-tenant environment such as, for example, the creation, deletion, updating, retrieval, searching, sorting, and reporting of files and other data objects.

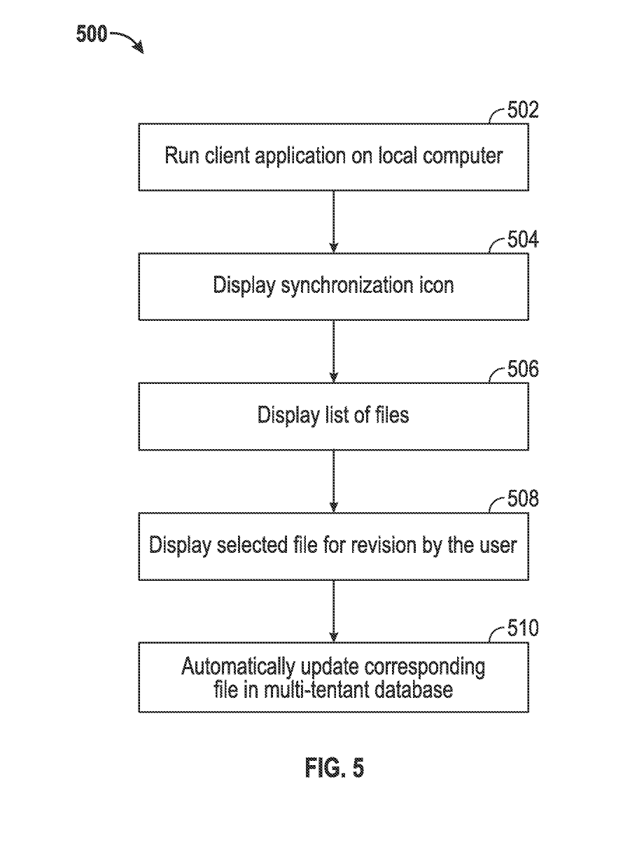

FIG. 5 is a flow chart illustrating an exemplary method 500 for automatically synchronizing data objects between a local computing device and a remote multi-tenant database. The method 500 includes running a client application on a local computing device (Task 502), displaying a synchronization icon on the local computing device (Task 504), and displaying a list of files on the local computing device in response to selection of the synchronization icon (Task 506). The method 500 further includes displaying, on the local computing device, a first file selected from the list (Task 508), and automatically updating, in the multi-tenant database, a second file corresponding to the first file when a user updates the first file at the local computer (Task 510).

A computer implemented application is thus provided for automatically synchronizing data objects between a local computing device and a remote multi-tenant database. The application includes a user interface module including a file manager configured to present a list of data objects to a user; a cross platform module configured to run the file management application on one of a plurality of operating systems; an authorization module configured to authenticate the user for access to a subset of the multi-tenant database; an application protocol interface (API) toolkit configured to perform user-selected functions on the data objects; and a file synchronizing engine configured to automatically synchronize the list of data objects with respective data objects in the multi-tenant database.

In one embodiment, the user-selected functions include creating, deleting, and updating the data objects, and the data objects comprise text files containing customer information including name, address, title, city, and state.

In another embodiment automatically synchronizing includes reconciling the current state of the list of data objects with corresponding data objects in the multi-tenant database without further (i.e., independent of) user action.

In an embodiment, the local computing device and the multi-tenant database are configured to communicate with each other through a network such as the internet.

In another embodiment the computing device may includes desk top computer, a lap top computer, a tablet, or any type of mobile computing device including a mobile telephone.

In a further embodiment the application comprises a single integrated code base configured to run on Windows, Mac, Linux, and/or any other suitable operating system.

In another embodiment, the subset of the multi-tenant database comprises tenant specific files within the multi-tenant database.

In a further embodiment the user interface module may be configured to display a synchronization file icon to the user, and to display a context specific menu to the user upon selection of the synchronization file icon, wherein the menu includes a website key and a file manager key.

In another embodiment the file synchronizing engine may be configured to monitor files and directories in the subset of the multi-tenant database and in the local computing device, and to reconcile updated files in real time.

A method is also provided for automatically synchronizing data objects in a multi-tenant database with corresponding data objects on a local computing device, wherein the multi-tenant computing environment is of the type including a server, a multi-tenant database, and a local computer connected to the multi-tenant database through a network cloud. The method includes running a client application on a local computing device, the client application including a file synchronizing module configured to maintain persistent connectivity between the multi-tenant database and the local computing device. The method further includes displaying a synchronization icon on the local computing device; displaying a list of files on the local computing device in response to selection of the synchronization icon; displaying, on the local computing device, a first file selected from the list; updating the displayed first file on the local computing device; and automatically updating, in the multi-tenant database, a second file corresponding to the first file upon updating the first file.

In an embodiment, running the client application comprises monitoring file creation, deletion, and revision for first files located on the local computing device and corresponding second files located in the multi-tenant database. The method may also include creating a third local file on the local computing device; dragging and dropping indicia of the third file into the list of files; and automatically creating a third remote file in the multi-tenant database corresponding to the third local file in response to the dragging and dropping.

In an embodiment, the method further involves displaying a context specific menu on the local computing device in response to selection of the synchronization icon, the menu including a web access key and a file manager key; and accessing a web-based portal associated with the multi-tenant database in response to user selection of the web access key. The method may also involve displaying an interactive file management user interface in response to user selection of the file manager key.

In another embodiment, updating the displayed first file on the local computing device comprises revising a text file associated with the first file using an API tool kit associated with the client application.

A computer application embodied in a non-transitory medium is also provided for operation by a computer processor for performing the steps of: running a client application on a local computing device; updating a first file on the local computing device; and automatically updating a second file in a remote multi-tenant database corresponding to the first file upon updating the first file.

In an embodiment, the client application includes a file synchronizing module configured to maintain persistent connectivity between the multi-tenant database and the local computing device, and automatically updating includes updating the second file user action.

The foregoing description is merely illustrative in nature and is not intended to limit the embodiments of the subject matter or the application and uses of such embodiments. Furthermore, there is no intention to be bound by any expressed or implied theory presented in the technical field, background, or the detailed description. As used herein, the word “exemplary” means “serving as an example, instance, or illustration.” Any implementation described herein as exemplary is not necessarily to be construed as preferred or advantageous over other implementations, and the exemplary embodiments described herein are not intended to limit the scope or applicability of the subject matter in any way.

For the sake of brevity, conventional techniques related to computer programming, computer networking, database querying, database statistics, query plan generation, XML and other functional aspects of the systems (and the individual operating components of the systems) may not be described in detail herein. In addition, those skilled in the art will appreciate that embodiments may be practiced in conjunction with any number of system and/or network architectures, data transmission protocols, and device configurations, and that the system described herein is merely one suitable example. Furthermore, certain terminology may be used herein for the purpose of reference only, and thus is not intended to be limiting. For example, the terms “first”, “second” and other such numerical terms do not imply a sequence or order unless clearly indicated by the context.

Embodiments of the subject matter may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In this regard, it should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In this regard, the subject matter described herein can be implemented in the context of any computer-implemented system and/or in connection with two or more separate and distinct computer-implemented systems that cooperate and communicate with one another. That said, in exemplary embodiments, the subject matter described herein is implemented in conjunction with a virtual customer relationship management (CRM) application in a multi-tenant environment.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application. Accordingly, details of the exemplary embodiments or other limitations described above should not be read into the claims absent a clear intention to the contrary.

What is claimed is:

1. A computer implemented application for automatically synchronizing data objects between a local computing device and a remote multi-tenant database, comprising:
a user interface module including a file manager configured to present a list of data objects to a user;
a cross platform module configured to run the file management application on one of a plurality of operating systems;
an authorization module configured to authenticate the user for access to a subset of the multi-tenant database;
an application protocol interface (API) toolkit configured to perform user-selected functions on the data objects; and
a file synchronizing engine configured to automatically synchronize the list of data objects with respective data objects in the multi-tenant database.

2. The application of claim 1, wherein the user-selected functions include creating, deleting, and updating the data objects.

3. The application of claim 2, wherein the data objects comprise text files containing customer information including name, address, title, city, and state.

4. The application of 1, wherein automatically synchronize comprises reconciling the current state of the list of data objects with corresponding data objects in the multi-tenant database independent of user action.

5. The application of 1, wherein the local computing device and the multi-tenant database are configured to communicate with each other through a network.

6. The application of 5, wherein the network is the internet.

7. The application of 1, wherein the computing device comprises one of a desk top computer, lap top computer, tablet, and a mobile computing device.

8. The application of 1, wherein the application comprises a single integrated code base configured to run on at least one of Windows, Mac, and Linux operating systems.

9. The application of 1, wherein the subset comprises tenant specific files within the multi-tenant database.

10. The application of 1, wherein the user interface module is further configured to display a synchronization file icon to the user.

11. The application of 10, wherein the user interface module is further configured to display a context specific menu to the user upon selection of the synchronization file icon, the menu including a website key and a file manager key.

12. The application of 1, wherein the file synchronizing engine is configured to monitor files and directories in the subset of the multi-tenant database and in the local computing device, and to reconcile updated files in real time.

13. In a multi-tenant computing environment of the type including a server, a multi-tenant database, and a local computer connected to the multi-tenant database through a network cloud, a method of automatically synchronizing data objects in the multi-tenant database with corresponding data objects on the local computing device, the method comprising:
running a client application on a local computing device, the client application including a file synchronizing module configured to maintain persistent connectivity between the multi-tenant database and the local computing device;
displaying a synchronization icon on the local computing device;
displaying a list of files on the local computing device in response to selection of the synchronization icon;
displaying, on the local computing device, a first file selected from the list;
updating the displayed first file on the local computing device; and
automatically updating, in the multi-tenant database, a second file corresponding to the first file upon updating the first file.

14. The method of claim 13, wherein running the client application comprises monitoring file creation, deletion, and revision for first files located on the local computing device and corresponding second files located in the multi-tenant database.

15. The method of claim 13, further comprising:
creating a third local file on the local computing device;
dragging and dropping indicia of the third file into the list of files; and
automatically creating a third remote file in the multi-tenant database corresponding to the third local file in response to the dragging and dropping.

16. The method of claim 13, further comprising:
displaying a context specific menu on the local computing device in response to selection of the synchronization icon, the menu including a web access key and a file manager key; and
accessing a web-based portal associated with the multi-tenant database in response to user selection of the web access key.

17. The method of claim 16, further comprising displaying an interactive file management user interface in response to user selection of the file manager key.

18. The method of claim 13, wherein updating the displayed first file on the local computing device comprises revising a text file associated with the first file using an API tool kit associated with the client application.

19. A computer application embodied in a non-transitory medium for operation by a computer processor for performing the steps of:
running a client application on a local computing device;
updating a first file on the local computing device; and
automatically updating a second file in a remote multi-tenant database corresponding to the first file upon updating the first file.

20. The computer application of claim 19, wherein the client application includes a file synchronizing module configured to maintain persistent connectivity between the multi-tenant database and the local computing device, and further wherein automatically updating comprises updating the second file user action.
